(19) United States
(12) Patent Application Publication
(10) Pub. No.: US 2018/0105011 A1
(43) Pub. Date: Apr. 19, 2018

(54) HVAC MODULE FOR VEHICLE

(71) Applicant: HYUNDAI MOTOR COMPANY, Seoul (KR)

(72) Inventors: June Kyu Park, Hwaseong-si (KR); Jong Sik Bae, Suwon-si (KR); Myung Hoe Kim, Seoul (KR)

(73) Assignee: HYUNDAI MOTOR COMPANY, Seoul (KR)

(21) Appl. No.: 15/375,822

(22) Filed: Dec. 12, 2016

(30) Foreign Application Priority Data
Oct. 18, 2016 (KR) 10-2016-0134827

(51) Int. Cl. B60H 1/00; B60H 1/22; B60H 1/32

(52) U.S. Cl. CPC B60H 1/00028; B60H 1/00514; B60H 1/00842; B60H 2001/2287; B60H 1/3202; B60H 2001/002; B60H 1/22

(57) ABSTRACT

A heating, ventilating and air-conditioning (HVAC) module for a vehicle is provided. In the HVAC module, a rear seat control module guiding a wind direction to a rear seat may be selectively assembled to a front seat control module including an evaporator and a heater such that only the front seat control module may be installed or an assembly of the front seat control module and the rear seat control module may be installed depending on each vehicle specification.

### CROSS-REFERENCE TO RELATED APPLICATION

This application claims under 35 U.S.C. § 119(a) the benefit of priority to Korean Patent Application No. 10-2016-0134827 filed on Oct. 18, 2016, the entire contents of which are incorporated herein by reference.

### BACKGROUND

### (a) Technical Field

The present disclosure relates to a heating, ventilating and air conditioning (HVAC) module for vehicle and, more particularly, to an HVAC module of an air-conditioning system for a vehicle in which a rear seat control module discharging air to a rear seat may be detachably mounted on a front seat control module discharging air only to a front seat.

### (b) Background Art

Generally, a heating, ventilating and air conditioning (HVAC) module is installed in a vehicle as an air-conditioning system for cooling and heating.

The HVAC module is configured to include a housing having an air inlet and an air outlet, an evaporator installed at the air inlet side of the housing to cool air, a heater installed in the housing to heat air, etc.

Further, a plurality of wind direction control doors for guiding a discharge direction of air is installed in the housing.

Therefore, when performing a cooling operation of the vehicle, air introduced through the air inlet of the housing passes through the evaporator to be cooled, and is then discharged along a guide direction of the wind direction control doors to an interior of the vehicle through a desired vent (a center vent, a side vent, a defroster, etc.). When performing a heating operation of the vehicle, air introduced through the air inlet of the housing passes through the heater to be heated, and then discharged along a guide direction of the wind direction control doors to the interior of the vehicle through a desired vent (the center vent, the side vent, the defroster, etc.).

The HVAC module has a structure having a front seat control module discharging air to a plurality of front seat outlets (an outlet toward the center vent, an outlet toward the side vent, an outlet toward the defroster, etc.) or a structure in which the front seat control module and a rear seat control module are integrated so as to discharge air to a rear seat outlet (an outlet toward a rear floor, an outlet toward a console vent, etc.) as well as to a front seat outlet.

In this case, the front seat control module has a structure guiding air to the front seat outlet and including the evaporator, the heater, etc., and the rear seat control module has a structure only guiding air to the rear seat outlet.

Accordingly, for each vehicle model, in a case of a low specification vehicle, an HVAC module having only the front seat control module is installed, and in a case of a high specification vehicle, an HVAC module having the front seat control module and the rear seat control module integrated to each other is installed.

As the HVAC module having only the front seat control module and the HVAC module having the front seat control module and the rear seat control module integrated to each other are separately manufactured, the number of steps from design to assembly production is large, such that workability and productivity deteriorate and manufacturing cost is increased.

### SUMMARY OF THE DISCLOSURE

The present application provides an HVAC module for a vehicle in which a rear seat control module guiding a wind direction to a rear seat may be selectively assembled to a front seat control module including an evaporator and a heater, such that only the front seat control module may be installed, or an assembly of the front seat control module and the rear seat control module may be installed depending on each vehicle specification.

In one aspect, a heating, ventilating and air-conditioning (HVAC) module for a vehicle includes a front seat control module including a housing, the housing having a front end portion, a rear end portion, and an upper portion. An air inlet is formed at the front end portion, a rear seat passage is formed at the rear end portion, and a plurality of front seat outlets are formed at the front end portion. An evaporator and a heater are installed in the housing while being spaced apart from each other. A cover is removably mounted at the rear seat passage of the housing. A rear seat control module is mounted at the rear seat passage that is opened in a state in which the cover is separated to guide a wind direction to a rear seat outlet.

In one embodiment, when only the front seat control module is installed in the vehicle, the cover may be sealably mounted at the rear seat passage of the housing, and when the front seat control module and the rear seat control module are installed in the vehicle together, the cover may be separated from the rear seat passage of the housing.

In another embodiment, four side edges of the cover may contact four side edges of the rear seat passage. The four side edges of the cover and the four side edges of the rear seat passage may be fastened with a screw or a bolt.

In still another embodiment, a gasket for maintaining air tightness may be inserted between the four side edges of the cover and the four side edges of the rear seat passage.

In yet another embodiment, the rear seat control module may include a front case fastened to the rear seat passage of the housing, the front case having an upper portion and a lower portion, a first rear seat wind direction control door rotatably mounted at the upper portion of the front case, a second rear seat wind direction control door rotatably mounted at the lower portion of the front case, a rear case integrally formed with the front case at a rear portion of the front case, the rear case having a rear end and a bottom portion, a console outlet integrally formed with the rear case at the rear end of the rear case, a rear floor outlet integrally formed with the rear case at a bottom portion of the rear case, and a third rear seat wind direction control door rotatably mounted in the rear case and guiding a wind direction to the console outlet or the rear floor outlet.

In still yet another embodiment, the third rear seat wind direction control door may be a rotary type door.

In a further embodiment, the rear seat passage of the front seat control module is manufactured to be blocked or opened when injection molding the housing.

### BRIEF DESCRIPTION OF THE DRAWINGS

Exemplary aspects are illustrated in the drawings. It is intended that the embodiments and figures disclosed herein are to be considered illustrative rather than restrictive.

FIG. 1 is a perspective view illustrating a front seat control module of an HVAC module for a vehicle;

FIG. 2 is a cross-sectional view illustrating the front seat control module of the HVAC module shown in FIG. 1, and an air flow at the time of cooling;

FIG. 3 is a cross-sectional view illustrating the front seat control module of the HVAC module shown in FIG. 1, and an air flow at the time of heating;

FIG. 4 is a perspective view illustrating a state in which a rear seat control module is mounted on the front seat control module of the HVAC module shown in FIG. 1;

FIG. 5 is a cross-sectional view illustrating a process of mounting the rear seat control module on the front seat control module of the HVAC module for a vehicle;

FIG. 6 is a cross-sectional view illustrating an air flow at the time of cooling in the state in which the rear seat control module is mounted on the front seat control module of the HVAC module for a vehicle;

FIG. 7 is a cross-sectional view illustrating an air flow at the time of heating in the state in which the rear seat control module is mounted on the front seat control module of the HVAC module for a vehicle; and

FIG. 8 is a cross-sectional view illustrating that the front seat control module of the HVAC module for a vehicle is manufactured to have a structure in which a rear seat passage is blocked in an injection molding process.

### DETAILED DESCRIPTION

Exemplary embodiments of the present disclosure are described in detail with reference to the accompanying drawings. The same reference numbers are used throughout the drawings to refer to the same or like parts. Detailed descriptions of well-known functions and structures incorporated herein may be omitted to avoid obscuring the subject matter of the present disclosure. Other exemplary embodiments or features may further be utilized, and other changes may be made, without departing from the scope of the subject matter presented herein. The exemplary embodiments described herein are not meant to be limiting. Thus, aspects of the present disclosure, as generally described herein and illustrated in the figures, can be arranged, substituted, combined, separated and designed in a wide variety of different configurations, all of which are explicitly contemplated herein.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

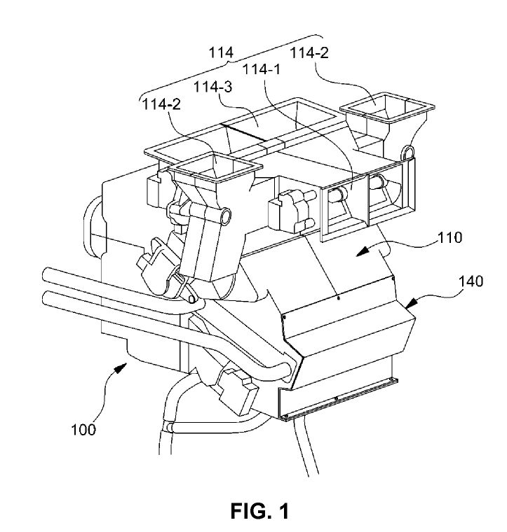

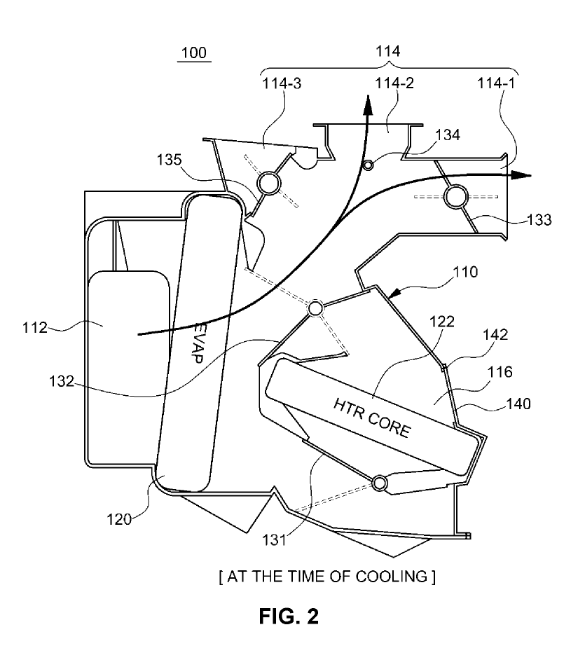

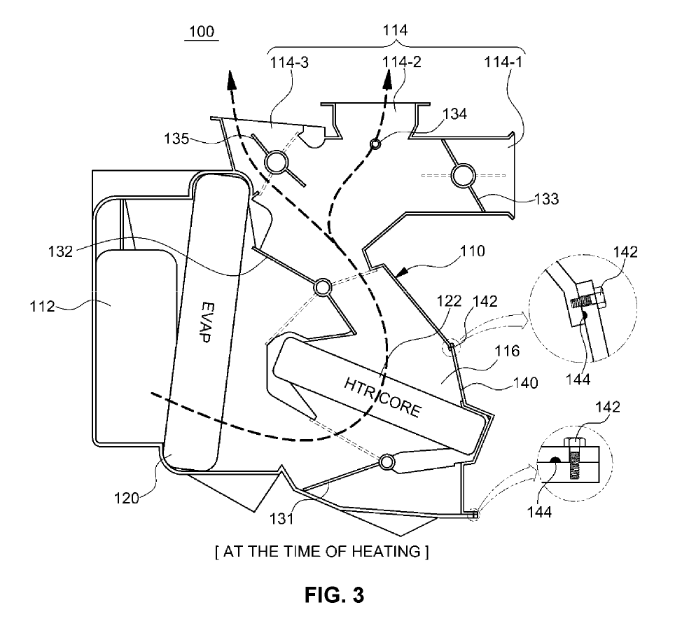

FIG. 1 illustrates a state in which assembly of a front seat control module of components of a heating, ventilating and air-conditioning (HVAC) module for a vehicle is completed, and FIGS. 2 and 3 illustrate air flow in the front seat control module at the time of cooling and air flow in the front seat control module at the time of heating, respectively.

A front seat control module 100 includes a housing 110 having a structure in which an air inlet 112 is formed at a front end portion of the front seat control module 100, a plurality of front seat outlets 114 is formed at an upper portion thereof, and a rear seat passage 116 is formed at a rear end portion thereof. The front seat outlets 114 include a center outlet 114-1 connected to a center vent formed in a center fascia between a driver's seat and a passenger seat, a side outlet 114-2 connected to a side vent formed in a crash pad, or the like in front of the driver's seat and the passenger seat, and a defroster outlet 114-3 connected to a defroster formed in the crash pad that is in contact with a wind shield glass.

The rear seat passage 116 of the housing 110 is formed in an opened state. When only the front seat control module 100 is installed in the vehicle, a cover 140 is mounted at the rear seat passage 116 so that air is not discharged through the rear seat passage 116. More specifically, the rear seat passage 116 is sealed by closely contacting four side edges of the cover 140 with four side edges of the opened rear seat passage and fastening portions. The four side edges of the cover 140 and the four side edges of the rear seat passage may be fastened together with a screw or a bolt 142. Preferably, in order to maintain air tightness, a gasket 144 may be inserted between the four side edges of the cover 140 and the four side edges of the rear seat passage 116.

Further, an evaporator 120 for cooling air during a cooling operation is installed at the air inlet 112 side in the housing of the front seat control module 100, and a heater 122 for heating air during a heating operation is installed at a rear side of the evaporator 120 while being spaced apart from the evaporator 120.

As shown in FIGS. 2 and 3, the housing 110 includes five or more front seat wind direction control doors. A first front seat wind direction control door 131 is removably mounted at an inlet of the heater 122. A second front seat wind direction control door 132 is mounted at a position that corresponds to an outlet of the evaporator 120 and an outlet of the heater 122, to open and close the outlet of the evaporator 120 or the outlet of the heater 122. A third front seat wind direction control door 133 is removably mounted at the center outlet 114-1. A fourth front seat wind direction control door 134 is openably mounted at the side outlet 114-2, and a fifth front seat wind direction control door 135 removably mounted at the defroster outlet 114-3. Although not illustrated, each front seat wind direction control door is opened and closed by an actuator driven by a control signal of a controller.

The front seat control module 100 manufactured as described above may be mounted alone in a low specification vehicle. When only the front seat control module 100 is installed in the vehicle, the front seat control module 100 is installed in a state in which the rear seat passage 116 formed in the housing 110 is sealed with the cover 140 in order to discharge air to a desired outlet of the front seat at the time of cooling or heating.

Cooling and heating operations performed in the front seat control module will be briefly described as follows.

Referring to FIG. 2, the first front seat wind direction control door 131 and the second front seat wind direction control door 132 close the inlet and the outlet of the heater 122, respectively, at the time of cooling, such that the outlet of the evaporator 120 communicates with respective front seat outlets.

Therefore, air cooled by the evaporator 120 is discharged into an interior of the vehicle through at least one of the center outlet 114-1, the side outlet 114-2, and the defroster outlet 114-3.

Referring to FIG. 3, the first front seat wind direction control door 131 and the second front seat wind direction control door 132 open the inlet and the outlet of the heater 122, respectively, at the time of heating, such that the outlet of the evaporator 120 is blocked from the respective front seat outlets, and at the same time, the outlet of the heater 122 communicates with the respective front seat outlets.

Therefore, air heated by the heater 122 is discharged into the interior of the vehicle through at least one of the center outlet 114-1, the side outlet 114-2, and the defroster outlet 114-3.

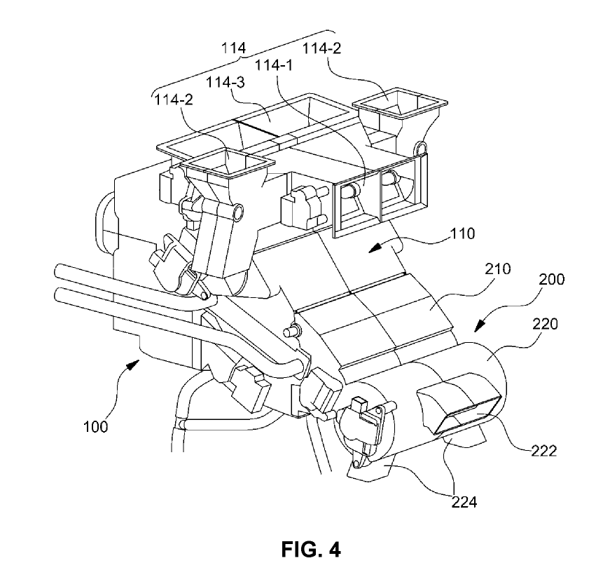

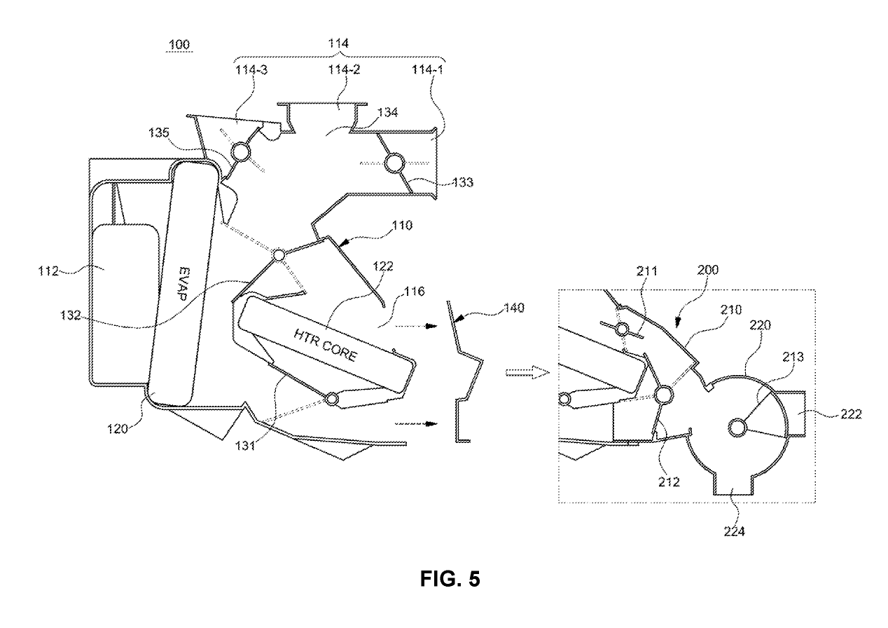

FIG. 4 illustrates a state in which the rear seat control module 200 is mounted on the front seat control module 100 of the HVAC module for a vehicle, and FIG. 5 illustrates a process of mounting the rear seat control module 200 on the front seat control module 100. The rear seat control module 200 includes a structure having a rear seat outlet (an outlet toward a rear floor and an outlet toward a console vent), and is assembled to the rear seat passage 116 after removing the cover 140 of the front seat control module 100 so that the rear seat control module 200 may communicate with the rear seat passage 116.

In a case in which the rear seat control module 200 guiding the wind direction to the rear seat needs to be installed in the vehicle in addition to the front seat control module 100, as shown in FIG. 5, the rear seat control module 200 is mounted at the opened rear seat passage 116 after removing the cover 140 from the housing 110 of the front seat control module 100.

The rear seat control module 200 includes a front case 210 fastened to the rear seat passage 116 of the housing 110, and a rear case 220 integrally formed with the front case 210 at a rear portion of the front case 210 as a framework thereof. A console outlet 222 connected to the console vent and a rear floor outlet 224 connected to the rear floor are formed at a rear end and a bottom portion of the rear case 220, respectively.

Further, a first rear seat wind direction control door 211 and a second rear seat wind direction control door 212 are rotatably mounted at an upper portion and a lower portion of the front case 210, respectively, and a third rear seat wind direction control door 213 guiding the wind direction to the console outlet 222 or the rear floor outlet 224 is rotatably mounted in the rear case 220. Preferably, the third rear seat wind direction control door 213 is a rotary-type door and serves to open and close the console outlet 222 or the rear floor outlet 224. Although not illustrated, each rear seat wind direction control door is opened and closed by the actuator driven by a control signal of the controller.

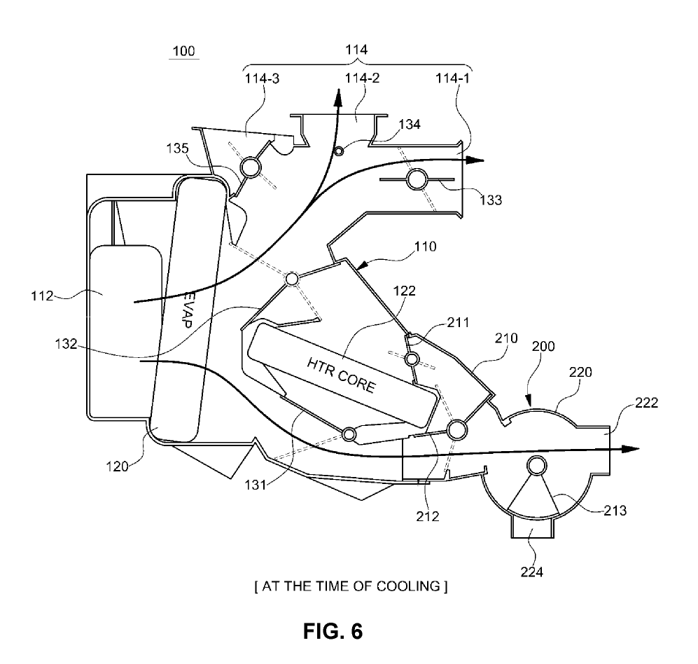

Referring to FIG. 6, the air flow in the front seat control module 100 at the time of cooling is as described above. The first rear seat wind direction control door 211 is closed to block the outlet of the heater 122, and at the same time, the second rear seat wind direction control door 212 is opened so that the outlet of the evaporator 120 communicates with the rear seat control module 200. Therefore, at the time of cooling, cooled air from the evaporator 120 enters the front case 210 and the rear case 220 of the rear seat control module 200, and then is discharged into the interior of the vehicle through the console outlet 222 or the rear floor outlet 224.

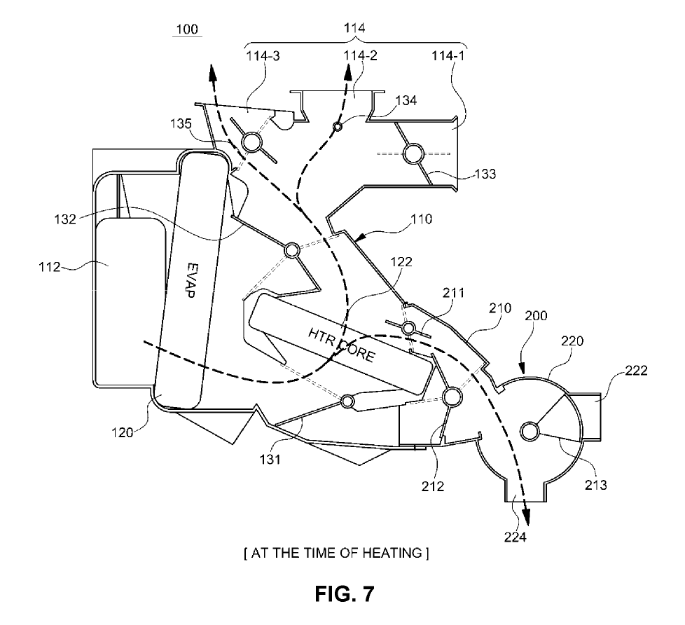

Referring to FIG. 7, the air flow in the front seat control module 100 at the time of heating is as described above. The first rear seat wind direction control door 211 is opened so that the outlet of the heater 122 communicates with the rear seat control module 200, and at the same time, the second rear seat wind direction control door 212 is closed so that the outlet of the evaporator 120 is blocked from the rear seat control module 200. Therefore, at the time of heating, warm air from the heater 122 enters the front case 210 and the rear case 220 of the rear seat control module 200, and then is discharged into the interior of the vehicle through the console outlet 222 or the rear floor outlet 224.

As such, since the rear seat control module 200 guiding the wind direction to the rear seat may be selectively assembled to the front seat control module 100 including the evaporator 120 and the heater 122, it is possible to supply air to both of the front seat and the rear seat, improve assemblability of a package for the vehicle and provide convenience so that the HVAC module may be selectively installed for each of high and low specification vehicles.

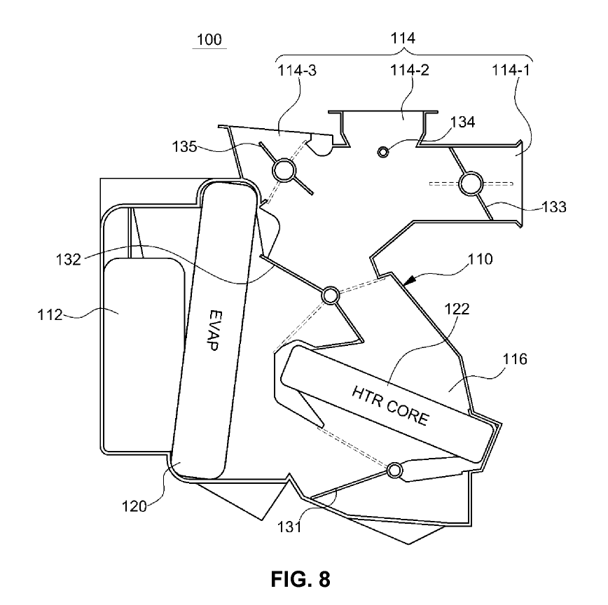

When injection molding the housing 110 of the front seat control module 100 described above, in order to mount the cover 140 at the rear seat passage 116 or mount the rear seat control module 200, the housing 110 can be molded while having the structure in which the rear seat passage 116 of the housing 110 is opened. However, as shown in FIG. 8, the housing 110 of the front seat control module 100 may be molded while having a structure in which the rear seat passage 116 of the housing 110 is blocked. By adding a slide core of a mold for injection molding the housing 110 of the front seat control module 100, the housing 110 may be molded while having a structure in which the rear seat passage 116 of the housing 110 is blocked, and thus, when only the front seat control module is installed in the vehicle, the front seat control module 100 having the structure in which the rear seat passage 116 of the housing 110 is blocked may be installed.

The present application facilitates the assembly of a package for a vehicle, since the HVAC module may be selectively installed for each of high and low specification vehicles. Further, productivity of the HVAC module can be improved and manufacturing cost decreased since not all components need to be installed on each HVAC module.

While a number of exemplary aspects have been discussed above, those of skill in the art will recognize that still further modifications, permutations, additions and sub-combinations thereof of the disclosed features are still possible. It is therefore intended that the following appended claims and claims hereafter introduced are interpreted to include all such modifications, permutations, additions and sub-combinations as are within their true spirit and scope.

What is claimed is:

1. A heating, ventilating and air-conditioning (HVAC) module for a vehicle, comprising:
a front seat control module including a housing, the housing having a front end portion, a rear end portion, and an upper portion, wherein an air inlet is formed at the front end portion, a rear seat passage is formed at the rear end portion, and a plurality of front seat outlets are formed at the front end portion;
an evaporator and a heater installed in the housing while being spaced apart from each other;
a cover separably mounted at the rear seat passage of the housing; and
a rear seat control module mounted at the rear seat passage that is opened in a state in which the cover is separated to guide a wind direction to a rear seat outlet.

2. The HVAC module of claim 1, wherein when only the front seat control module is installed in the vehicle, the cover is sealably mounted at the rear seat passage of the housing, and when the front seat control module and the rear seat control module are installed in the vehicle together, the cover is separated from the rear seat passage of the housing.

3. The HVAC module of claim 1, wherein four side edges of the cover contact four side edges of the rear seat passage and are fastened together with a screw or a bolt.

4. The HVAC module of claim 3, wherein a gasket for maintaining air tightness is inserted between the four side edges of the cover and the four side edges of the rear seat passage.

5. The HVAC module of claim 1, wherein the rear seat control module comprises:
a front case fastened to the rear seat passage of the housing, the front case having an upper portion and a lower portion;
a first rear seat wind direction control door rotatably mounted at the upper portion of the front case;
a second rear seat wind direction control door rotatably mounted at the lower portion of the front case;
a rear case integrally formed with the front case at a rear portion of the front case, the rear case having a rear end and a bottom portion;
a console outlet integrally formed with the rear case at the rear end of the rear case;
a rear floor outlet integrally formed with the rear case at a bottom portion of the rear case; and
a third rear seat wind direction control door rotatably mounted in the rear case and guiding a wind direction to the console outlet or the rear floor outlet.

6. The HVAC module of claim 5, wherein the third rear seat wind direction control door is a rotary type door. The HVAC module of claim 1, wherein the rear seat passage of the front seat control module is manufactured to be blocked or opened when injection-molding the housing.
